(19) United States
(12) Patent Application Publication
(10) Pub. No.: US 2012/0247716 A1
(43) Pub. Date: Oct. 4, 2012

(54) Motor Vehicle Cooling System

(75) Inventors: Gunter Galtz, Strasslach (DE); Markus Renner, Riemerling (DE); Theresia Koppe, Gilching (DE)

(73) Assignee: Webasto AG, Stockdorf/Gauting (DE)

(21) Appl. No.: 13/496,851

(22) PCT Filed: Dec. 6, 2010
(86) PCT No.: PCT/DE2010/075156

§ 371 Date: May 29, 2012

(30) Foreign Application Priority Data
Dec. 21, 2009 (DE) 10 2009 059 240.7

(51) Int. Cl. B60H 1/00; B60H 1/32

(52) U.S. Cl. 165/42; 165/41

(57) ABSTRACT

The invention relates to a motor vehicle cooling system, comprising a first cooling circuit, in which a coolant can be circulated, at least one electrical component of the vehicle, which is integrated in the first cooling circuit and is to be cooled, wherein the electrical component can be cooled by means of a coolant that can be circulated in the first cooling circuit, a refrigeration system, which is designed to provide cooling capacity, and a refrigerant-coolant heat exchanger, which is designed to transfer the cooling capacity provided by the refrigeration system to the coolant. A first coolant-air heat exchanger for cooling air for a vehicle interior is arranged in the first cooling circuit.

The present invention relates to a motor vehicle cooling system, in particular a motor vehicle cooling system which is designed to cool at least one electrical component to be cooled and air for a vehicle interior space.

Within the scope of the search for alternative drive concepts for motor vehicles, in particular for road vehicles, there is a trend in the direction of what are referred to as hybrid vehicles which have an electric drive motor and an internal combustion drive engine, and in the direction of electric vehicles which only have an electric drive motor. In such vehicles, a traction battery is provided which is configured to make available the energy which is necessary to drive the vehicle by means of the electric drive motor. In addition, in such vehicles, power electronics are provided which are used when the vehicle is driven by means of the electric drive motor. The traction battery, the power electronics and the electric drive motor heat up during operation and it is necessary to cool them in order to maintain the functional capability and to prevent damage owing to excessively high temperatures. The traction battery, the power electronics and the electric drive motor therefore form vehicle electrical components which have to be cooled. In particular, with respect to the traction battery, it is necessary with known battery types to keep them in a temperature range between a temperature lower limit and a temperature upper limit in order to ensure a long service life so that depending on the operating state and the ambient temperature it may also be necessary to heat them actively.

In some operating states, and depending on the ambient temperatures, the situation may occur in which the electric components to be cooled cannot be sufficiently cooled by means of air cooling with external air, and active cooling therefore has to be provided, which uses the cooling capacity of a refrigeration system.

DE 44 08 960 C1 describes a device for cooling a traction battery of an electric vehicle. It is described that a cooling circuit is provided with an air-to-water heat exchanger for conducting away waste heat to external air, and a cooling unit whose vaporizer is in thermal contact with this cooling circuit and which can be activated according to requirements in order to maintain the desired battery temperature.

In addition, in motor vehicles it has become customary to provide cooling of the air for a vehicle interior space in order to improve the comfort of passengers. The necessary cooling capacity is usually also made available here by a refrigeration system, generally by a compressor-operated air conditioning system.

The object of the present invention is to make available an improved motor vehicle cooling system which provides cooling of electrical components to be cooled and of air for a vehicle interior space, with a compact design.

This object is achieved by means of a motor vehicle cooling system as claimed in claim 1. Advantageous developments are specified in the dependent claims.

The motor vehicle cooling system has: a first cooling circuit in which a cooling liquid can be circulated; at least one electrical component of the vehicle which is to be cooled and is connected into the first cooling circuit and can be cooled by means of the cooling liquid which can be circulated in the first cooling circuit; a refrigeration system which is designed to provide cooling capacity; and a coolant-to-cooling liquid heat exchanger which is designed to transfer the cooling capacity provided by the refrigeration system to the cooling liquid. A first cooling liquid-to-air heat exchanger for cooling air for an interior space of a vehicle is arranged in the first cooling circuit.

Motor vehicles are understood here to be land vehicles, watercraft and aircraft which have a drive engine/motor. The drive engine/motor can be formed here, for example, by an internal combustion engine, by an electric motor or by what is referred to as a hybrid drive. The present invention is advantageous here in particular when electric motors and hybrid drives are used in which a traction battery, an electric drive motor and associated power electronics give off heat which has to be carried away. A cooling circuit is understood within the scope of this description to be a circuit in which a cooling liquid can be circulated in order to cool components which are connected into the circuit. A “cooling liquid” is understood here to be a liquid which serves to transport heat in the circuit without passing through phase transitions (liquid to gaseous). A liquid which is used in such a way that it vaporizes in a circuit and is condensed again in order to make available cooling capacity when vaporizes is, in contrast to this, referred to as a “coolant”. The cooling liquid used may be, for example, in a known fashion, water, a water glycol mixture or water with further additives. An “electrical component to be cooled” is understood here to be a component from which heat has to be carried away so that it does not overheat. In particular, an electrical component to be cooled is not understood to be an electrical component which is supplied with electrical power for the purpose of making available heat such as, for example, in the case of a resistance heater, for example a PTC element. Air for a vehicle interior space is understood here to be air which is fed to a vehicle interior space in order to condition said interior space. The term “conditioning” is understood here to mean cooling, heating or dehumidifying the vehicle interior space and/or supplying it with fresh air. A coolant-to-cooling liquid heat exchanger is understood to be a heat exchanger which is designed to transmit heat between a coolant and a cooling liquid. A cooling liquid-to-air heat exchanger is understood to be a heat exchanger which is designed to transmit heat between a cooling liquid and air.

Since the first cooling liquid-to-air heat exchanger for cooling air for a vehicle interior space is arranged in the first cooling circuit, the air for the vehicle interior space is cooled indirectly by means of the first cooling circuit. This makes possible a compact design of the refrigeration system, in which the lengths of coolant-conducting components can be restricted to a minimum amount. For example, in the case of a design with a compressor, condenser, expansion valve and vaporizer with a coolant-to-cooling liquid heat exchanger the latter may be combined in one compact unit. Coolant losses can be minimized since the length of coolant-conducting connections can be reduced. Since means of conducting cooling liquid can be implemented significantly more cost-effectively than means for conducting a coolant (in terms of pressure conditions, tightness, etc.), this permits cost savings to be made. The resulting compact design of the refrigeration system reduces the volume of the coolant, the weight and the system costs of the refrigeration system. It is possible to use a cooling liquid circuit which is already present in electric and hybrid vehicles. If an existing cooling circuit is used in an electric or hybrid vehicle, it is also easily possible to make available a multi-zone air-conditioning system in which cooling capacity can be tapped at various locations in respect of the vehicle interior space, since the cooling capacity can be made available by a plurality of cooling liquid-to-air heat exchangers, connected into the cooling circuit, for the vehicle interior space. A further advantage is that in order to cool the air for a vehicle interior space there is no need to install any coolant-conducting components in the air stream of a heating, ventilation and air-conditioning system (HVAC module, heating, ventilation, air-conditioning). The cooling liquid can be formed, for example, by means of customary cooling water such as, for example, a water/glycol mixture with possible further additives. According to the inventive solution, the cooling circuit is therefore used both for cooling the electrical components to be cooled and for cooling the vehicle interior space.

According to one refinement, the first cooling liquid-to-air heat exchanger is arranged in the first cooling circuit downstream of the coolant-to-cooling liquid heat exchanger and upstream of the at least one electrical component, to be cooled, of the vehicle between the coolant-to-cooling liquid heat exchanger and the at least one electrical component to be cooled. The terms downstream and upstream relate here to the direction of flow in which the cooling liquid is circulated in the first cooling circuit. In this arrangement, it is possible, when necessary, to feed very cold cooling liquid from the coolant-to-cooling liquid heat exchanger to the cooling liquid-to-air heat exchanger in order to make available a high cooling capacity for the vehicle interior space. The cooling liquid only subsequently passes to the electrical component to be cooled, where it is heated by the waste heat to be carried away. As a result, both the interior space and the electrical components can be cooled efficiently.

According to one refinement, the at least one electrical component to be cooled comprises a traction battery of an electric vehicle or hybrid vehicle. In particular, high cooling capacities have to be made available for traction batteries during operation, which is reliably achieved by means of the specified system.

According to one refinement, a second cooling circuit is provided in which cooling liquid can be circulated and by means of which heat can be conducted away to outside air from the at least one electrical component to be cooled, by means of a further cooling liquid-to-air heat exchanger. In this case, there are two possibilities available for cooling the at least one electrical component to be cooled, so that various operating states of the motor vehicle cooling circuit can be made available as a function of external circumstances. If the at least one component to be cooled is connected in in such a way that it can be optionally coupled into the first cooling circuit or into the second cooling circuit, it can, for example, be partially or completely decoupled from the second cooling circuit, with the result that the latter is available for other purposes. If there is no need for any cooling capacity from the refrigeration system, the electrical component to be cooled can be decoupled from the first circuit so that its cooling is carried out exclusively by means of the second cooling circuit.

According to one refinement, a vehicle heating device is provided which is connected into the motor vehicle cooling system in order to heat cooling liquid. In this case, the motor vehicle cooling system can also be used at the same time for heating air for the vehicle interior space if this is desired and/or for heating the electrical components if this is necessary. A “vehicle heating device” is understood in this context to be a device which is provided in a vehicle for the purpose of making available heating capacity such as, for example, a fuel-operated vehicle heating apparatus or an electric resistance heater.

According to one refinement, the vehicle heating device is connected in in such a way that the at least one electrical component can be heated by means of cooling liquid heated by the vehicle heating device. In this case, the cooling liquid in the motor vehicle cooling system is also used to heat the electrical component if this is necessary, such as, for example, when there are cold external temperatures.

According to one refinement, the vehicle heating device is connected in in such a way that the air for the vehicle interior space can be heated by means of cooling liquid heated by the vehicle heating device. In this case, the cooling liquid in the motor vehicle cooling system is also used to heat the air for the vehicle interior space if this is desired.

According to one refinement, the vehicle heating device has a fuel-operated heating apparatus and/or an electric resistance heater. If a fuel-operated heating apparatus is provided, heating capacity can be made available for the electrical components and/or the vehicle interior space without loading the electrical energy stores present in the vehicle, which would lead to a reduction in the range of the vehicle. If an electric resistance heater is provided, heating capacity can be made available for the electrical components and/or the vehicle interior space even if it is not possible or not permitted to operate a fuel-operated heating apparatus. This may be the case, for example, if the vehicle is located in a garage or in a zero emission zone.

According to one refinement, the vehicle heating device has an electric resistance heater and is designed to heat exclusively electrically when an external electrical power supply is available. An external power supply may be available, in particular, when a traction battery of an electric or hybrid vehicle is being charged. In this case, when an external electric power supply is available no fuel is consumed, as would be the case when heating by means of a fuel-operated heating apparatus.

According to one refinement, the vehicle heating device can be decoupled from the part of the vehicle cooling system in which the at least one electrical component is connected in in such a way that a third circuit is formed. By means of the third circuit, the air for the vehicle interior space can be heated by means of cooling liquid heated by the vehicle heating device, without feeding heat given off by the vehicle heating device to the at least one electrical component. In this case, where necessary a high heating capacity can be supplied to the vehicle interior space by the vehicle heating device and there is in this context no risk of the electrical components being subjected to high temperatures.

Further advantages and developments emerge from the embodiment described below with reference to the drawings, in which:

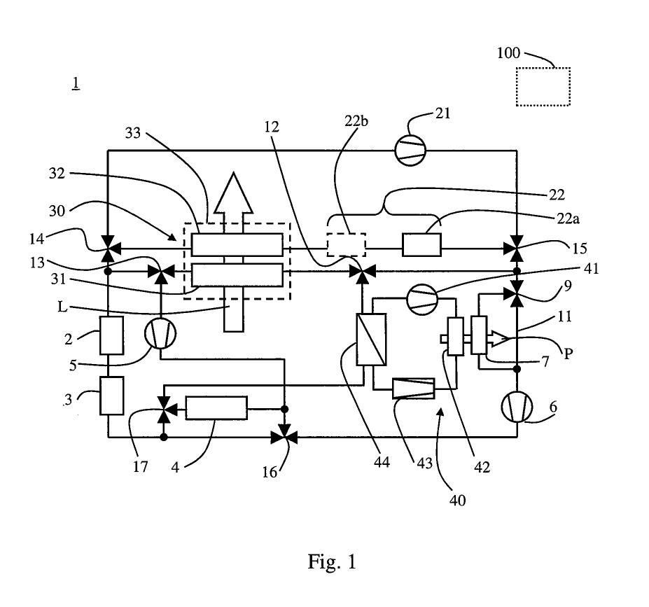

FIG. 1 is a schematic view of the design of a motor vehicle cooling system according to one embodiment,

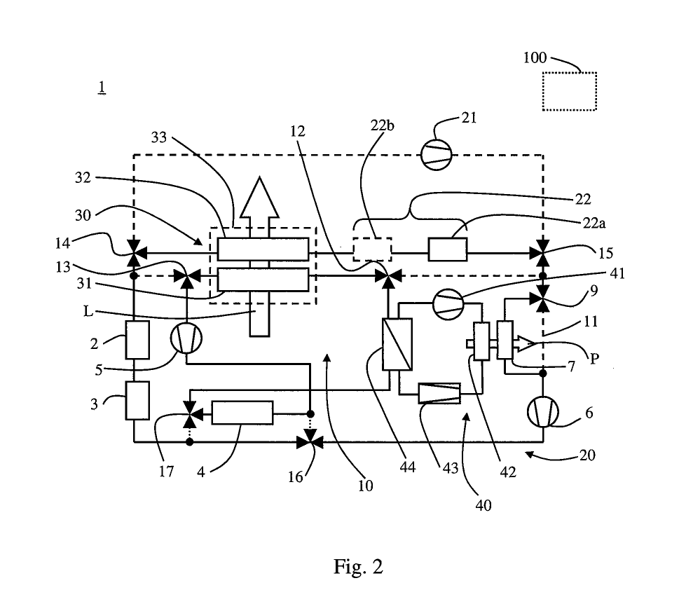

FIG. 2 is a schematic illustration explaining the operation in a first operating state,

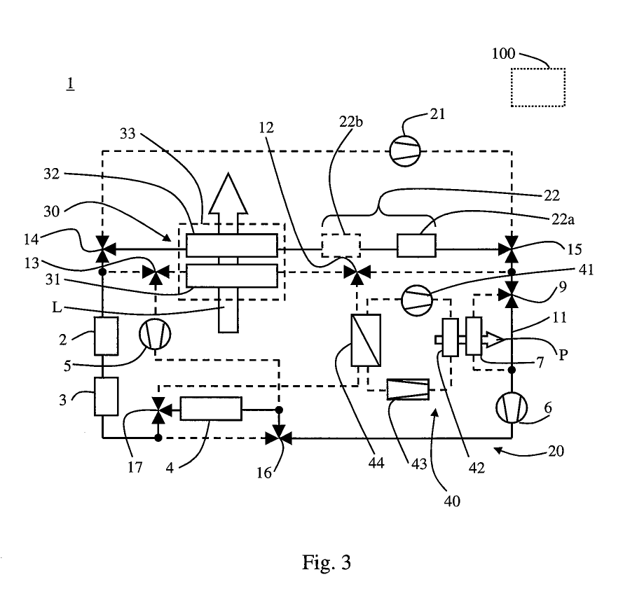

FIG. 3 is a schematic illustration explaining the operation in a second operating state, and

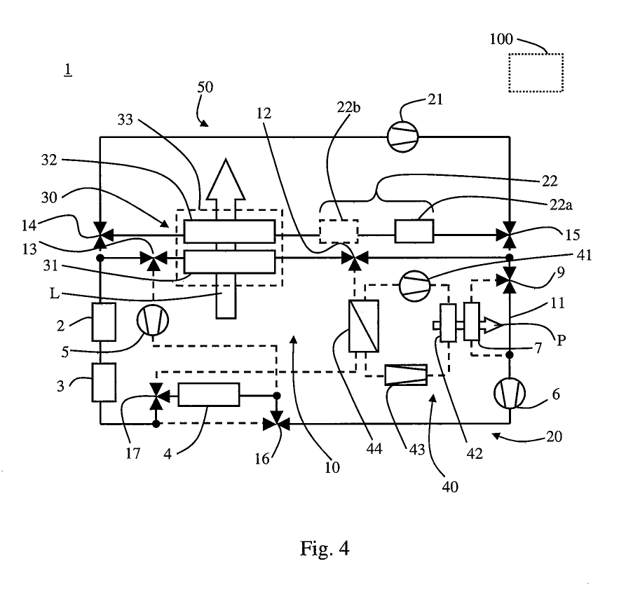

FIG. 4 is a schematic illustration explaining the operation in a third operating state.

An embodiment is described below with reference to FIGS. 1 to 4. FIG. 1 shows a motor vehicle cooling system 1 according to an embodiment. In the illustrated embodiment, the motor vehicle cooling system 1 is implemented in an electric vehicle which is driven by means of an electric motor 2. Power electronics 3 are provided which form an electronic component of the drive train. In addition, a traction battery 4 is provided for supplying the power electronics 3 and the electric motor 2 with electrical energy. The traction battery 4, the power electronics 3 and the electric motor 2 form vehicle electrical components to be cooled. Heat has to be carried away during operation from these components to be cooled (at least in some operating states of the vehicle), in order to maintain the operation and prevent damage to components.

In the embodiment, the motor vehicle cooling system 1 has, in addition to the electrical components already described (traction battery 4, power electronics 3 and electric motor 2), further components which are described below.

A two-part heat exchanger arrangement 30 is provided which has a cooling liquid-to-air heat exchanger 31 and a second cooling liquid-to-air heat exchanger 32. The heat exchanger arrangement 30 is designed to be subjected to an air flow of air to be conditioned for a vehicle interior space, as illustrated schematically by an arrow L. The air is supplied in the vehicle to a vehicle interior space which is to be conditioned, which may be formed, for example, by the passenger compartment of the vehicle. The heat exchanger arrangement 30 can be arranged, for example, in the flow path of a heating, ventilating and air-conditioning system (HVAC module) of the vehicle in which an air stream is made available by a blower. The heat exchanger arrangement 30 is arranged here in such a way that the air stream flows round it or through it. The first cooling liquid-to-air heat exchanger 31 is designed such that heat is transmitted from a circulated cooling liquid to the air for the vehicle interior space and/or extracted from said air. This will be described in more detail below. The second cooling liquid-to-air heat exchanger 32 is designed and arranged in such a way that heat from circulated cooling liquid is transmitted to the air for the vehicle interior space. This is also described in more detail below. The first cooling liquid-to-air heat exchanger 31 and the second cooling liquid-to-air heat exchanger 32 are arranged in a common housing 33, as indicated schematically in FIG. 1 by a dashed box, in the illustrated embodiment. The common housing 33 is designed here to be arranged in the air flow path of a heating, ventilation and air-conditioning system (HVAC module) of a vehicle. The first cooling liquid-to-air heat exchanger 31 and the second cooling liquid-to-air heat exchanger 32 are arranged thermally decoupled from one another here, with the result that their temperatures do not significantly influence one another. The first cooling liquid-to-air heat exchanger 31 and the second cooling liquid-to-air heat exchanger 32 are arranged in such a way that the air to be conditioned for the vehicle interior space is firstly applied to the first cooling liquid-to-air heat exchanger 31 and then to the second cooling liquid-to-air heat exchanger 32.

In addition, a vehicle heating device 22 is provided. In the illustrated embodiment, the vehicle heating device 22 has a fuel-operated heating apparatus 22a which makes available heat by converting fuel with combustion air. The fuel-operated heating apparatus is embodied as a liquid heating apparatus in which the heat which is made available is transmitted to the cooling liquid. As is represented by dashes in FIG. 1, the vehicle heating device 22 can alternatively or additionally also have an electric resistance heating element 22b which is designed to transmit heat which is given off to the cooling liquid.

The motor vehicle cooling system 1 also has a further cooling liquid-to-air heat exchanger 7. A bypass line 11, with which the cooling liquid can optionally be circulated while bypassing the cooling liquid-to-air heat exchanger 7, is provided in the region of the cooling liquid-to-air heat exchanger 7. A valve 9 is provided with which it is possible to adjust what proportion the circulated cooling liquid is directed through the cooling liquid-to-air heat exchanger 7 and what proportion is circulated through the bypass line 11. The valve 9 is connected to a schematically illustrated controller 100 and can be actuated by means of the latter. The valve 9 can be embodied, for example, as a solenoid valve. The cooling liquid-to-air heat exchanger 7 is designed to carry away heat to outside air. It is designed such that it can be subjected to an air flow with which heat can be carried away to the outside to the surroundings of the vehicle, as is illustrated schematically by an arrow P.

The described components of the motor vehicle cooling system 1 are connected to one another via connecting lines in which cooling liquid can be circulated. Pumps 5, 6 and 21 are provided with which cooling liquid can be circulated in various regions of the motor vehicle cooling system. The motor vehicle cooling system 1 also has valves 12, 13, 14, 15, 16 and 17 with which it is possible to set through which regions of the motor vehicle cooling system 1 cooling liquid is respectively circulated. The valves 12, 13, 14, 15, 16 and 17 are connected to the controller 100 and can be actuated by means of the latter. The valves can be formed, for example, by solenoid valves.

In addition, a refrigeration system 40 is provided which has a compressor 41, a condenser 42, an expansion valve 43 and a vaporizer. The vaporizer has a coolant-to-cooling liquid heat exchanger 44. The refrigeration system 40 is designed to operate in a known fashion with a coolant and to make available cooling capacity by vaporizing the coolant. For this purpose, the refrigeration system 40 is operated cyclically. In the illustrated embodiment, the refrigeration system 40 is formed by a conventional refrigeration system in which gaseous coolant is compressed in the compressor 41, condensed in the condenser 42 to form liquid coolant, subjected to a reduction in pressure in the expansion valve 43 and vaporized in the vaporizer. The cooling capacity which is made available by the vaporization process is transmitted to cooling liquid in the coolant-to-cooling liquid heat exchanger 44. However, it is to be noted that other refrigeration systems such as, for example, absorption refrigeration systems or adsorption refrigeration systems can also be used. In the illustrated embodiment, the condenser 42 has an air cooler which is combined with the cooling liquid-to-air heat exchanger 7 and is cooled by the same air stream P. The coolant-to-cooling liquid heat exchanger 44 is connected via connecting lines to the other components of the motor vehicle cooling system 1 which conduct cooling liquid.

In the text which follows, a description is given of operation of the motor vehicle cooling system 1 in a first operating state with reference to FIG. 1 and FIG. 2. In the first operating state, on the one hand the electrical components to be cooled (in the embodiment: the traction battery 4, the power electronics 3 and the electric motor 2) are cooled and, on the other hand, the air for the vehicle interior space is also cooled, as is apparent from the following description. This is an operating state which is used, for example, in an implementation in a car in the summer. In FIG. 2, the lines which are placed, via the valves 9, 12, 13, 14, 15, 16 and 17, in a state in which no cooling liquid is circulated through them, are represented as dashed lines. Lines in which a partial flow is made optionally possible via the valves 16 and 17 are represented by dots. The controller 100 sets the valves 9, 12, 13, 14, 15, 16 and 17 in such a way that the flows of the cooling liquid which are described in the text which follows are implemented.

In the first operating state, the refrigeration system 40 is operating and the cooling liquid is cooled in the coolant-to-cooling liquid heat exchanger 44 with the cooling capacity of the refrigeration system 40. The cooled cooling liquid is fed by means of the pump 5 firstly through the first cooling liquid-to-air heat exchanger 31 and then to the traction battery 4 which forms an electrical component to be cooled. A high cooling capacity is therefore made available in the first cooling liquid-to-air heat exchanger 31 since the cooling liquid is at a low temperature level which is made available by the refrigeration system 40. The cooling liquid, which is already at a somewhat higher temperature level after the first cooling liquid-to-air heat exchanger 31, then serves to cool the traction battery 4 located downstream. The cooling liquid flows back again to the coolant-to-cooling liquid heat exchanger 44 from the traction battery 4. In this way, a first cooling circuit 10 is formed in which cooling liquid is circulated which is cooled with the cooling capacity which is made available by the refrigeration system 40. The first cooling circuit has here the coolant-to-cooling liquid heat exchanger 44, the first cooling liquid-to-air heat exchanger 31, the pump 5, the traction battery 4 as an electrical component to be cooled as well as the lines which connect these components.

In addition, in the first operating state a second cooling circuit 20 is formed via which cooling liquid is circulated. Cooling liquid is circulated by means of the pump 6 via the power electronics 3 and the electric motor 2, which form electrical components to be cooled, the second cooling liquid-to-air heat exchanger 32, the vehicle heating device 22 and the further cooling liquid-to-air heat exchanger 7. The vehicle heating device 22 is in a switched-off state here, in which it does not transmit any heating warmth to the circulated cooling liquid. Waste heat is carried away from the electrical components to be cooled (in the exemplary embodiment the power electronics 3 and the electric motor 2) by means of the circulated cooling liquid. The cooling liquid which is circulated in the second cooling circuit 20 is cooled here by means of the further cooling liquid-to-air heat exchanger 7. The portion of circulated cooling liquid which flows through the cooling liquid-to-air heat exchanger 7 can be controlled here by means of the valve 9 in order to make available the necessary cooling capacity. If there is only a small cooling requirement, a portion of the cooling liquid can flow through the bypass line 11.

In the first operating state, the second cooling circuit 20 therefore has the power electronics 3 and the electric motor 2 as electrical components to be cooled, the second cooling liquid-to-air heat exchanger 32, the further cooling liquid-to-air heat exchanger 7 and the pump 6. The vehicle heating device 22 is also connected into the second cooling circuit 20 in a switched-off state. The cooling liquid which is circulated in the second cooling circuit 20 is at a higher temperature level here than the cooling liquid which is circulated in the first cooling circuit 10.

The temperature of the traction battery 4 has to be kept in a predefined temperature range which should not be exceeded or undershot. For this reason, the valves 16 and 17 are actuated in such a way that cooling liquid from the second cooling circuit upstream of the traction battery 4 can be mixed into the cooling liquid circulated in the first cooling circuit 10, and a portion of the cooling liquid can flow back again into the second cooling circuit 20 downstream of the traction battery 4. In this way, the necessary temperature of the cooling liquid for the traction battery 4 is set.

In the first operating state, the air from the vehicle interior space is therefore cooled efficiently by means of the first cooling liquid-to-air heat exchanger 31 and at the same time sufficient cooling capacity for the electrical components to be cooled is made available. The air for the vehicle interior space, which flows through the two-part heat exchanger arrangement 30, is cooled to a low temperature in the first cooling liquid-to-air heat exchanger 31 and therefore dehumidified to a high degree. In the second cooling liquid-to-air heat exchanger 32, counter-heating takes place with the waste heat from the electrical components, with the result that the air is heated again to a somewhat higher second temperature level. In this way, highly dehumidified air is made available at the second temperature level.

In the text which follows, a second operating state will now be described with reference to FIG. 1 and FIG. 3. The valves 9, 12, 13, 14, 15, 16 and 17 are in turn actuated by the controller 100. For the sake of clarification, the lines in which no cooling liquid is circulated are represented by dashes in FIG. 3. In the second operating state, the refrigeration system 40, the pump 5 and the pump 21 are not operating. The vehicle heating device 22 is operating, in order to heat the circulated cooling liquid. No cooling liquid is therefore circulated in the first cooling circuit 10 in the second operating state. The traction battery 4 is connected into the second cooling circuit 20 by means of the position of the valves 16 and 17. The cooling liquid which is heated by the vehicle heating device 22 is circulated by means of the pump 6 through the electrical components (traction battery 4, power electronics 3, electric motor 2) and the second cooling liquid-to-air heat exchanger 32. By means of a corresponding position of the valve 9, the heated cooling liquid flows through the bypass line 11 while bypassing the further cooling liquid-to-air heat exchanger 7. This second operating state can be used, in particular, in winter if both the electrical components and the vehicle interior space are to be heated.

In the second operating state, the electrical components (which are not to be cooled in this case) are heated or kept at a sufficiently high temperature by means of the cooling liquid heated by the vehicle heating device 22. The air for the vehicle interior space is heated by means of the second cooling liquid-to-air heat exchanger 32 using the cooling liquid heated by the vehicle heating device 22.

A third operating state is described in the text which follows with reference to FIG. 1 and FIG. 4. In FIG. 4, those connecting lines in which no cooling liquid is circulated owing to the corresponding positions of the valves 9, 12, 13, 14, 15, 16 and 17 are in turn represented by dashes for the purpose of illustration. In the third operating state, the air for the vehicle interior space is to be heated and the electrical components to be cooled (traction battery 4, power electronics 3 and electric motor 2) are to be cooled. In one implementation in a car, the third operating state is used, for example, when the car is driven in winter by means of the electric motor 2, with the result that, on the one hand, the traction battery 4, the power electronics 3 and the electric motor 2 have to be heated and cooled and, on the other hand, the vehicle interior space has to be heated.

In the third operating state, the refrigeration system 40 and the pump 5 are not operating. In the first cooling circuit 10, no cooling liquid is circulated. The valves 9, 12, 13, 14, 15, 16 and 17 (in particular the valves 14 and 15) are actuated in such a way that a third liquid circuit 50 is formed, which is disconnected from the second liquid circuit 20. In the third liquid circuit 50, cooling liquid is circulated through the vehicle heating device 22 and the second cooling liquid-to-air heat exchanger 32 by means of the pump 21. The vehicle heating device 22 is operating here and heats the cooling liquid circulated in the third cooling liquid circuit 50. In the second cooling liquid-to-air heat exchanger 32, air is heated for the vehicle interior space by means of the heated cooling liquid. If the electrical components to be cooled in the third operating state make available sufficient waste heat to heat the vehicle interior space, the vehicle heating device 22 can also be switched off.

The valves 16 and 17 are again set in the third operating state in such a way that the traction battery 4 and the further electrical components to be cooled (power electronics 3 and electric motor 2) are connected into the second cooling circuit 20. However, in contrast to the first operating state and the second operating state, in the third operating state the second cooling circuit 20 is not closed by means of the second cooling liquid-to-air heat exchanger 32 and the heating device 22 but rather by means of the first cooling liquid-to-air heat exchanger 31, as is illustrated in FIG. 4. In the third operating state, the second cooling circuit 20 has the electrical components to be cooled (traction battery 4, power electronics 3 and electric motor 2), the first cooling liquid-to-air heat exchanger 31 and the pump 6. Cooling liquid is circulated in the second cooling circuit 20 by means of the pump 6.

The waste heat which is output by the electrical components to be cooled is used in the first cooling liquid-to-air heat exchanger 31 to heat the air for the vehicle interior space. Depending on whether the waste heat of the electrical components is sufficient or not, the third liquid circuit 50 may, or may not, be used with the vehicle heating device 32 to heat further the air in the second cooling liquid-to-air heat exchanger 32 to a higher temperature level. In this way, the waste heat from the electrical components is used efficiently and the vehicle heating device 22 only needs to be operated when the waste heat of the electrical components is not sufficient. Even then the vehicle heating device 22 only needs to be operated in order to bring about the still necessary difference in heating capacity. In this way, the vehicle interior space can be heated in a way which is very economical in terms of energy. If the conduction away of heat via the first cooling liquid-to-air heat exchanger 31 from the second cooling circuit 20 is not sufficient, the valve 9 can also be set in such a way that heat is also conducted away to outside air via the further cooling liquid-to-air heat exchanger 7. The efficient use of the waste heat of the electrical components for heating brings about a significant extension of the range of an electric vehicle drive compared with a case in which heating is carried out exclusively by means of electric resistance heaters. In addition, a lower discharge of the traction battery 4 occurs, which reduces the battery charging time and increases the service life of the battery.

According to one preferred refinement, the vehicle heating device 22 is operated in such a way that when an external electrical power supply is available (for example when the traction battery 4 is being charged) only the electric resistance heating element 22b is activated, i.e. the fuel-operated heating apparatus 22a is not activated. In this case, when an external electrical power supply is available there is a saving in fuel.

In the embodiment, the vaporizer of the refrigeration system 40 is embodied as a coolant-to-cooling liquid heat exchanger 44 which cools cooling liquid which can be made available by a known chiller. The cooling liquid uses the existing cooling circuit of the vehicle which is provided for cooling electrical components to be cooled. The cooling circuit is used here in a double function both for cooling electrical components and for cooling air for a vehicle interior space. Owing to this refinement, the refrigeration system 40, which serves both to cool electrical components and to cool the vehicle interior space, can be arranged in the vehicle in a compact fashion. The coolant circuit of the refrigeration system does not need to be made to extend to a flow path of the heating, ventilation and air-conditioning system (HVAC module) in order to make available cooling of the air for the vehicle interior space. In addition, the electrical components to be cooled such as, for example, the traction battery 4, power electronics 3 and electric motor 2, can be cooled by means of the cooling liquid circuit and do not have to be connected into the coolant circuit for cooling by means of a refrigeration system, which would involve high expenditure owing to the high working pressure of the refrigeration system.

Owing to the indirect cooling both of the electrical components to be cooled and the air for the vehicle interior space, the refrigeration system can be implemented in a compact design. The compressor, condenser, expansion valve and vaporizer with heat exchanger as well as the connecting lines can be combined in one unit. The coolant-conducting components are in this way reduced to short lengths and a small number of connecting pieces, which reduces the risk of losses of coolant. Owing to the compact design which is made possible for the refrigeration system 40, the volume of the coolant, the weight and the system costs of the refrigeration system are reduced.

By using the cooling circuit, the cooling liquid serves as a refrigerant outside the compact refrigeration system. For this reason, components cooled by cooling liquid can be sufficiently cooled by a simple connection of the cooling circuit and there is no need for any coolant-conducting components to be installed in the air stream of the air for the vehicle interior space.

By using the cooling circuit which, in electric vehicles or hybrid vehicles, usually runs through (almost) the entire vehicle, a multi-zone air-conditioning system of the vehicle interior space can be implemented without difficulty by connecting a plurality of cooling liquid-to-air heat exchangers for cooling air for the vehicle interior space at various locations in the vehicle into the cooling circuit 10. In this context, the connection into the circuit preferably occurs in each case in the circulation direction between the coolant-to-cooling liquid heat exchanger 44 and the electrical components to be cooled.

Although only the traction battery 4 is connected into the first cooling circuit 10 as an electrical component to be cooled in the exemplary embodiment described above, it is also possible to connect further electrical components to be cooled, for example the power electronics 3 and the electric motor 2 etc., into the first cooling circuit 10, in particular also to connect them in such a way that optional connection into the first cooling circuit 10 and into the second cooling circuit 20 is made possible.

1. A motor vehicle cooling system having:
a first cooling circuit in which a cooling liquid can be circulated,
at least one electrical component of the vehicle which is to be cooled and is connected into the first cooling circuit and can be cooled by means of the cooling liquid which can be circulated in the first cooling circuit,
a refrigeration system which is designed to provide cooling capacity, and
a coolant-to-cooling liquid heat exchanger which is designed to transfer the cooling capacity provided by the refrigeration system to the cooling liquid,
characterized in that a first cooling liquid-to-air heat exchanger for cooling air for an interior space of a vehicle is arranged in the first cooling circuit.

2. The motor vehicle cooling system as claimed in claim 1, characterized in that the first cooling liquid-to-air heat exchanger is arranged in the first cooling circuit downstream of the coolant-to-cooling liquid heat exchanger and upstream of the at least one electrical component, to be cooled, of the vehicle between the coolant-to-cooling liquid heat exchanger and the at least one electrical component to be cooled.

3. The motor vehicle cooling system as claimed in claim 1, characterized in that the at least one electrical component to be cooled comprises a traction battery of an electric vehicle or hybrid vehicle.

4. The motor vehicle cooling system as claimed in claim 1, characterized in that a second cooling circuit is provided in which cooling liquid can be circulated and by means of which heat can be conducted away to outside air from the at least one electrical component to be cooled, by means of a further cooling liquid-to-air heat exchanger.

5. The motor vehicle cooling system as claimed in claim 4, characterized in that the at least one component to be cooled can be optionally coupled into the first cooling circuit or into the second cooling circuit.

6. The motor vehicle cooling system as claimed in claim 1, characterized in that a vehicle heating device is provided which is connected into the motor vehicle cooling system in order to heat cooling liquid.

7. The motor vehicle cooling system as claimed in claim 6, characterized in that the vehicle heating device is connected in in such a way that the at least one electrical component can be heated by means of cooling liquid heated by the vehicle heating device.

8. The motor vehicle cooling system as claimed in claim 6, characterized in that the vehicle heating device is connected in in such a way that the air for the vehicle interior space can be heated by means of cooling liquid heated by the vehicle heating device.

9. The motor vehicle cooling system as claimed in claim 6, characterized in that the vehicle heating device comprises a fuel-operated heating apparatus and/or an electric resistance heater.

10. The motor vehicle cooling system as claimed in claim 6, characterized in that the vehicle heating device comprises an electric resistance heater and is designed to heat exclusively electrically when an external electrical power supply is available.

11. The motor vehicle cooling system as claimed in claim 6, characterized in that the vehicle heating device can be decoupled from the part of the vehicle cooling system in which the at least one electrical component is connected in such a way that a third circuit is formed, by means of which the air for the vehicle interior space can be heated by means of cooling liquid heated by the vehicle heating device, without feeding heat given off by the vehicle heating device to the at least one electrical component.

12. The motor vehicle cooling system as claimed in claim 1, characterized in that a second cooling liquid-to-air heat exchanger is provided for counter-heating the air cooled in the first cooling liquid-to-air heat exchanger with waste heat from at least one electrical component to be cooled.
